(19) United States
(12) Patent Application Publication
(10) Pub. No.: US 2007/0203718 A1
(43) Pub. Date: Aug. 30, 2007

(54) Computing system for modeling of regulatory practices

(75) Inventor: Eric S. Merrifield JR., Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/361,199

(22) Filed: Feb. 24, 2006

(51) Int. Cl. G06Q 10/00; G07G 1/00; G06Q 30/00; G06F 17/30

(52) U.S. Cl. 705/1; 705/10

(57) ABSTRACT

A system and method for providing a business architecture model which clearly identifies regulatory practices applicable to a business, and how these regulatory practices affect different aspects of a business. The business architecture model according to the present system and method may also be easily modified to model the costs and effects of compliance, non-compliance and hypothetical changes to the regulatory practices of a business. Once the model is set up, it can monitor and manage some or all aspects of a business' regulatory practices in an automated manner. The model may be integrated with a business' information technology infrastructure to manage and keep track of regulatory practices, as well as to provide notifications when an event occurs related to the regulatory practice.

### BACKGROUND

A business needs to have a clear understanding of the often complex nature of its business operations in order to be successful. Various mechanisms have been developed to model and represent a business. Some mechanisms include manual generation of diagrams that represent business processes that describe how work is done. For example, all aspects of a business can be analyzed to identify business capabilities, interrelationships and interdependencies between the various business operations. Based on the analysis, representative diagrams can be generated which graphically illustrate a business architecture and process flow.

However, accurate analysis of a business from a business process point of view can often take a long time to put together, and since many business processes are dynamic, changing over time, a manually generated representation of business processes may be outdated even before it is completed. Further, even if a manually generated representation of business processes were accurate at the time it was completed, changes in business processes after the business representation is generated would lead to inaccuracies in the business representation. And once representative diagrams are generated, such diagrams are not easily modified without a further investment of time, effort and resources. Thus, manually generated representations provide limited ability for a business to understand its current operations and/or determine how actual or hypothetical changes to various business capabilities would affect the business.

At least in part as a result of the above-described deficiencies, some software application programs have been developed to generate representations of business architectures. These application programs use various techniques to model and represent a business, mostly focusing on modeling business processes and detailed procedures that support those processes. Some of these application programs generate a graphical view of business processes for display over a graphical user interface. To some limited extent, these graphical views can be altered to simulate the effect of a change in different business capabilities on a business.

A shortcoming of some of these application programs is that they describe a business in terms of “how” the business is executed, focusing for example on organizational structure, procedures and process flows. In so doing, much of the detail and granularity of the business may be lost or subsumed into these categories. In particular, businesses generally include some measure of vertical and horizontal integration of layers, and may have many interrelated business units. In focusing a business model in terms of how the business is executed, much of the vertical and horizontal layering and interrelation of different units may be lost. A change in these aspects of a business may be critical, but may nonetheless be obscured in such business models.

Moreover, how a business operates may change over time, and thus criteria such as organizational structure, procedures and process flows to describe a business are relatively unstable. The useful life time of a model of a business architecture is only as valid as the least stable input.

Further, many application programs for modeling business architectures include hard-coded data types and hard-coded representations for business modeling input data. These hard-coded data types and representations can be difficult to alter without access to source code. Thus, the flexibility and extensibility of modeling businesses and generating corresponding views is limited. For example, it may be difficult to alter predefined data formats such that a business capability can be represented in a different way or such that a previously undefined business capability can be added.

An important practice in any business is the ability to keep current and knowledgeable on all applicable federal, state and local compliance regulations. It is also important for the business to have internal procedures and governance practices for ensuring compliance with these regulations, tracking costs associated with compliance, as well as understanding the consequences for non-compliance. As a few examples, businesses need to understand and have governance practices for complying with wage and labor laws, health and safety laws, environmental laws, and tax and tariff regulations. Failure to do so may result in substantial penalties or even closure. In reality, for a lot of organizations, failure to comply is less because of fraud or malice, than because of an inability to understand the specifics of governance and compliance regulations and how to map them to their business in a way that allows for proper prioritization and decision-making. And that is typically because people lack a simple way to capture the governance and compliance regulations in a consistent, structured way, and because they lack the tools to link those regulations to a stable map of their organization. This represents a known risk for many businesses, but one which they cannot quantify, or measure progress against, because of a lack of tools to enable them to measure and manage this risk.

The importance to businesses of compliance and governance practices has become even more significant in light of the implementation of the Sarbanes-Oxley Act in 2002. The Act requires the creation of internal auditing committees, as well as reporting and ethical conduct requirements for certain businesses, and provides for stern penalties and possible jail sentences for non-compliance. The Act impacts many facets of a business, including its accounting practices, IT practices, legal department, administration and management. So beyond what is for many companies an already overly complex, voluminous and growing set of regulations, Sarbanes-Oxley has added a degree of urgency to manage and report compliance—without offering much in the way of tools or guidelines with respect to how to manage that.

Current business architecture models are not well equipped to adequately define and represent regulatory business practices rigorously and consistently in a way that allows easy linkage of those regulations to the business capabilities. Nor do they have adequate mechanisms for identifying the costs of compliance and non-compliance with applicable regulations. Furthermore, under certain regulations, such as the Sarbanes-Oxley Act, a business must be able to pinpoint detailed events and practices within the business, and be able to understand and show how these events and practices affect their compliance obligations. Traditional business architecture models do not allow for this level of scrutiny, nor do they allow this level of scrutiny to be implemented in the model.

### SUMMARY

The present system, roughly described, relates to a software application program and method for providing a business architecture model which clearly identifies regulatory practices applicable to a business, and how these regulatory practices affect different aspects of a business. The business architecture model according to the present system and method may also be easily modified to model the costs and effects of compliance, non-compliance and hypothetical changes to the regulatory practices of a business.

In embodiments, the present software application program and method relating to regulatory practices makes use of, and integrates with, a recently developed paradigm for modeling businesses, referred to herein as “business capability modeling.” Business capability modeling focuses on the capabilities of a business, i.e., on “what” a business does, which criteria are more objective and stable than criteria that focus on “how” a business operates.

The stand-alone repository of regulatory practices includes regulations. Regulations may include rules with which the business must comply by law, custom, or practice recognized as binding an external agency or internally within the business. The stand-alone repository of regulatory practices may further include internal governance practices. Internal governance practices are those practices imposed by the business for complying with the regulations. A business architecture including regulatory practices may be a conceptual model, a visual model or a data model.

The data model provides a powerful operational view of a business. In embodiments, once set up, the data model itself can monitor and manage some or all aspects of a business' regulatory practices in an automated manner. For example, the model may be integrated with a business' information technology (“IT”) architecture to manage and keep track of regulatory practices, as well as to provide notifications when an event occurs related to the regulatory practices (i.e., some action to be taken to comply with an applicable regulation, some action to be taken to indicate the compliance action has or has not been taken, etc.).

### BRIEF DESCRIPTION OF THE DRAWINGS

FIG. 1 illustrates a portion of a sample business architecture map according to the visual business capability model.

FIG. 2 is a flowchart according to an embodiment of the present system for providing a conceptual model of a business including regulatory practices.

FIG. 3 is a flowchart according to an embodiment of the present system for providing a visual model of a business including regulatory practices.

FIG. 4 illustrates a portion of a sample business architecture map including regulatory practices according to the visual business capability model.

FIG. 5 is a flowchart according to an embodiment of the present system for providing a data model of a business including regulatory practices.

FIGS. 6A and 6B illustrate an example capability modeling schema that can be used for modeling a business based upon business capabilities and regulatory practices.

FIG. 7 is a block diagram of a computer hardware for implementing embodiments of the present system.

### DETAILED DESCRIPTION

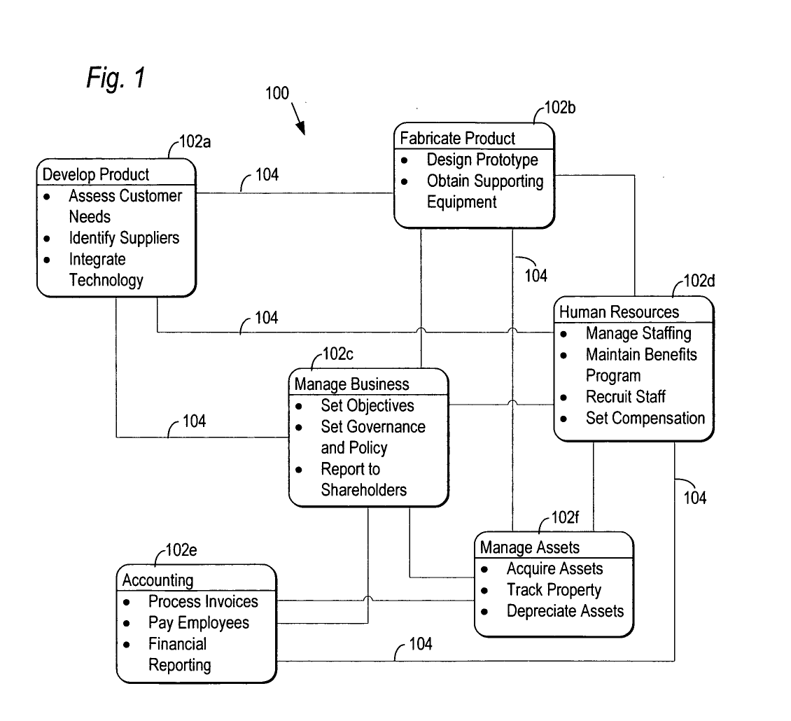

The present system will now be described with reference to FIGS. 1 through 7, which in embodiments relate to a software application program and method for providing a business architecture model which clearly identifies regulatory practices applicable to a business, and how these regulatory practices affect different aspects of a business. The business architecture model according to the present system and method may also be easily modified to model the costs and effects of compliance, non-compliance and hypothetical changes to the regulatory practices of a business.

In embodiments, the software application program and method of the present system may be a stand-alone repository of regulatory practices, as well as their relation to other business capabilities. This stand-alone repository of regulatory practices advantageously makes use of, and integrates neatly with, the paradigm of business capability modeling. As explained in the Background section, traditional business models that focus on “how” a business works base the models on relatively subjective and unstable criteria. Business capability modeling focuses instead on “what” a business does which is more objective and stable. Further details relating to business capability modeling are described in the following patent applications:
applicant's copending U.S. patent application Ser. No.10/999,852, entitled, “EFFICIENT AND FLEXIBLE BUSINESS MODELING BASED UPON STRUCTURED BUSINESS CAPABILITIES,” filed Nov. 29, 2004 (MS#310362.01);
applicant's copending U.S. patent application Ser. No. 11/094,988, entitled, “ASSOCIATION AND VISUALIZATION OF SCHEMATIZED BUSINESS NETWORKS,” filed Mar. 31,2005 (MS#310218.01);
applicant's copending U.S. patent application Ser. No. 11/094,926, entitled, “COMPARING AND CONTRASTING MODELS OF BUSINESS,” filed Mar. 31, 2005 (MS#310219.01); and
applicant's copending U.S. patent application Ser. No.11/112,777, entitled, “TRANSFORMATION FRAMEWORK,” filed Apr. 22,2005 (MS#310220.01).
   Each of the above-identified four patent applications is incorporated by reference herein in its entirety. It is understood that, while this model is well suited to relating regulations with business capabilities, it can also be valuable in relating those same regulations to the less stable views of business such as process.

In general, the business capability model starts with capturing all of the capabilities that a business performs. The capabilities of a complete business may or may not coincide with the boundaries of a given corporate entity. In other words, with awareness of all of the capabilities that make up an entire business, a company may choose to outsource many areas of the business architecture, or partner with another company. Such business capabilities may include the business capability of paying its employees, the business capability of managing its inventory, and the business capability of reporting business events to stockholders, etc. These business capabilities are merely a few examples—most businesses would have many hundreds to over a thousand such business capabilities to fully describe its business architecture.

Business capabilities may cover such practices as business communications, business relationships, business dependencies, business connections (e.g., to other business capabilities), and business boundaries (between the company and other companies, or between the company and customers, or a financial services organization, and so forth). Business capability dependencies can include, for example, what needs to happen for the business capability to start (in the example of paying employees above—this capability will often have a time dependency), what needs to happen for the business capability to finish, what other business capabilities depend on the business capability. Business capability boundaries can include, for example, indications of a business capability being influenced by entities, processes, or technology internal to a business and entities (e.g., partners, suppliers, customers, financial services organizations, government organizations, etc.) external to the business.

Business capabilities may also cover measurement and analysis aspects of a business. Measurement and analysis aspects can indicate how the success of a business capability is measured, who owns the business capability, who is the customer of the business capability, notification criteria for variations in the business capability performance, workarounds if a business capability is not available, acceptable variations in inputs to and outputs of the business capability (for example, in some instances five inputs of some type may always be needed for a certain capability to start, while others may be time driven rather than volume driven—though volume can still be a valuable measure), the stability and/or volatility of the business capability (how often it changes, whether performance variations are from a common cause or not, and so forth), the importance of the business capability (does it or does it not directly relate to the key performance indicators of the organization), etc. Business capabilities may cover a wide variety of other business aspects, interrelations and practices.

Once the capabilities of a given business have been captured (and it does not have to be an exhaustive exercise for it to add significant value to an organization), each business capability may then be mapped, and related capabilities connected, to provide a conceptual model of a business which reveals in detail exactly what a business does and how those capabilities relate to each other. Two capabilities may be related to each other where a first capability may impact a second capability within the business. They may be related for example by cause and effect, consecutive events in a chain of events, vertical and horizontal association, and/or by a variety of other relationships.

The above-described capture of all business capabilities and their relation to each other provides a detailed conceptual model of a business architecture. This capture of all business capabilities and their relation may alternatively or additionally provide a detailed visual model of a business, for example over a graphical user interface or printout. For example, when displayed over a user interface, all capabilities may be represented as graphical objects on the display, such as for example graphical boxes labeled with the capability name, and related capabilities may be connected to each other by graphical lines and/or arrows.

Graphical arrows leading into a given graphical business capability represent inputs to the business capability and indicate that the given business capability is somehow impacted by the business capability to which it is connected. Likewise, graphical arrows leading away from a given graphical business capability represent outputs from the business capability, and indicate that the given business capability somehow impacts the business capability to which it is connected. Stated another way, inputs and outputs are the artifacts and events that are consumed and/or produced by business capabilities. They represent what is outward and visible about the behavior of the capabilities. Thus, for example, a “pay employee” capability may have inputs of employee name and wage, and may have an output to a financial institution or service for paying the employee. A given business capability may have multiple inputs and/or outputs. A graphical line, as opposed to an arrow, may represent two-way communication between the business capabilities.

Connections are used to represent relationships between business capabilities, and can represent a variety of different relationships between business capabilities. For example, a connection can indicate a flow of data between two digital business capabilities. A connection may represent the flow of services between two business capabilities. A connection may represent supervision of one capability over another. Other relationships are contemplated. Connections can represent a one way relationship or a two way relationship.

In a further embodiment of the business capability model, as opposed to merely representing a conceptual or visual model of a business, the business capabilities and connections may be represented in software as data to provide a robust operational model of a business architecture. The data model allows for detailed understanding of each business capability, its place in the overall business and for aggregating the capabilities into systems which allow for management, change planning and hypothetical change analysis.

In the data model, in addition to merely capturing business capabilities and their relation to other business capabilities, each business capability may be analyzed to discern its properties, or “attributes.” Attributes of a business capability are used to described the characteristics of the business capability, and may include who is responsible (or owns) the capability, the relative impact the capability has on the overall performance of the business, what events trigger the capability, what happens when the capability is triggered, etc. A business capability may have anywhere from one attribute to one-hundred or more attributes. It will be up to each organization to determine what is most valuable for them in terms of how many attributes to capture in this model.

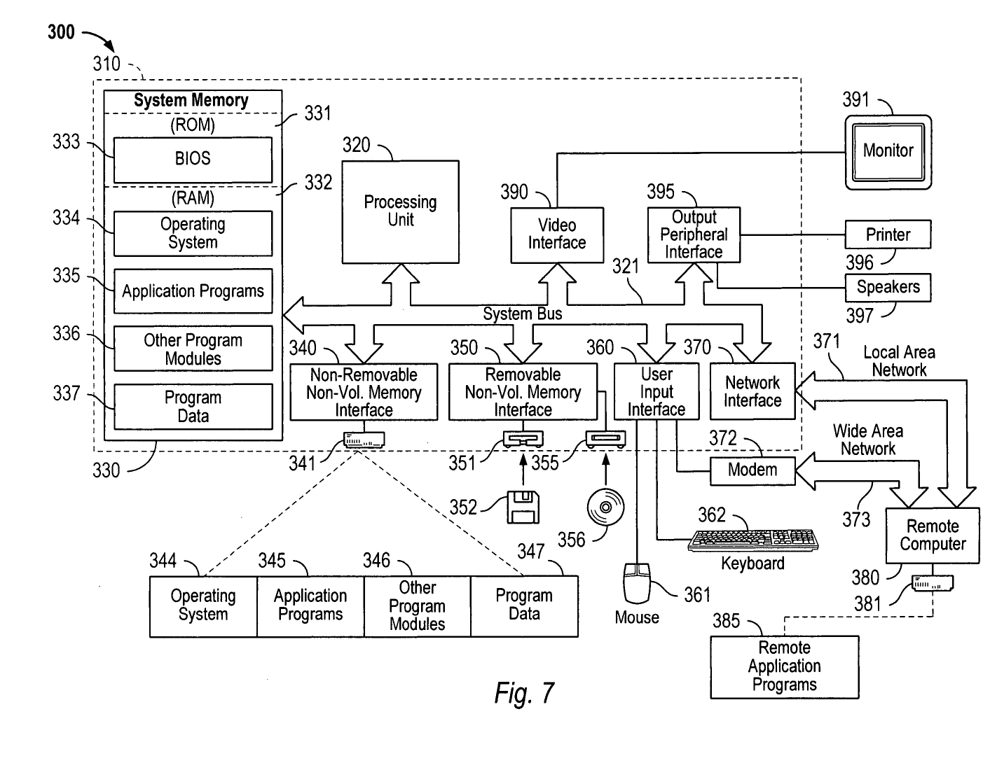

In the data model of a business architecture, the various business capabilities, and business capability attributes for each business capability, may be stored in a database within a computing system (such as the computer system explained hereinafter with respect to FIG. 7). Those business capabilities that are connected to each other, as described above, may be linked so as to exchange information with each other. The exchanged information relates to the business capability attribute(s) of the respective business capabilities.

The information relating to the business capabilities and capability attributes may be formatted according to a variety of selected schemas. The schemas can be utilized to define virtually any data type for the capabilities and capability attributes, including logical, binary, octal, decimal, hexadecimal, integer, floating-point, character, character string, user-defined data types, and combinations of these data types used to define data structures. Further details relating to business capabilities, business capability attributes and formatting of capabilities and capability attributes according to a selected schema are set forth in the above-identified incorporated patent applications.

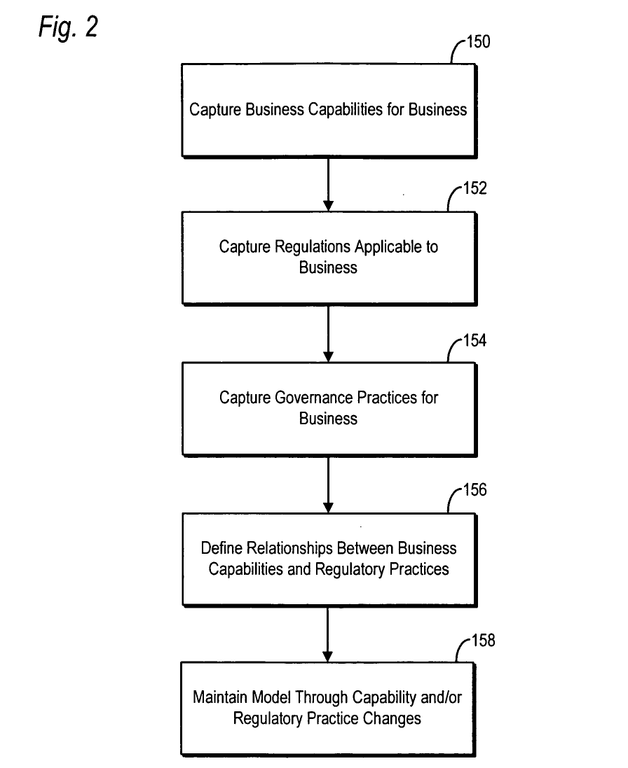

FIG. 1 illustrates a portion of a sample, high-level, business architecture map 100 according to the visual business capability model. The map 100 shows a number of business capabilities 102 linked to each other by connections 104. The business capabilities 102 include “Develop Product” 102a, “Fabricate Product” 102b, “Manage Business” 102c, “Human Resources” 102d, “Accounting” 102e and “Manage Assets” 102f. Each business capability 102 further has subcategories of business capabilities as well that fall within the general headings of the listed business capabilities. Connections 104 show how and which business capabilities are related to each other. As indicated above, although there is no set number of business capabilities or connections, a map for a typical business may include many more business capabilities 102 and connections 104 than shown in FIG. 1. Moreover, it is understood that the business capabilities 102 may have other and different relations to each other in different business models. The business map 100 of FIG. 1 is illustrated for ease of explanation. FIG. 1 does not show business regulations, which are explained in greater detail hereinafter with respect to FIGS. 2-6B.

In accordance with the present system, a business architecture model may further include a stand-alone repository of regulatory practices for a business, as well as the relation of those regulatory practices to the business capabilities. In general, the regulatory practices from the stand-alone repository of regulatory practices may be integrated with the business capabilities by linking the regulatory practices to one or more business capabilities to provide a conceptual, visual and/or data model of an overall business architecture.

The stand-alone repository may be the database of the regulatory practices. In embodiments, the database of regulatory practices may be separate from or included as part of the database for the business capabilities, capability attributes, connections, etc. In an alternative embodiment, the regulatory practices may not be included in a stand-alone repository, but may be formed, integrated and stored together with the business capabilities, capability attributes, connections, etc.

The stand-alone repository of regulatory practices includes regulations. Regulations may include rules with which the business must comply by law, and/or by any custom, practice or action formally recognized as binding or enforced by an external agency or controlling authority. Regulations may also include any custom, practice or action formally recognized as binding or enforced by the business. The stand-alone repository of regulatory practices may further include internal governance practices. Internal governance practices are those practices imposed by the business for complying with the regulations. Thus, the stand-alone repository of business practices may include: 1) regulations, and 2) governance practices.

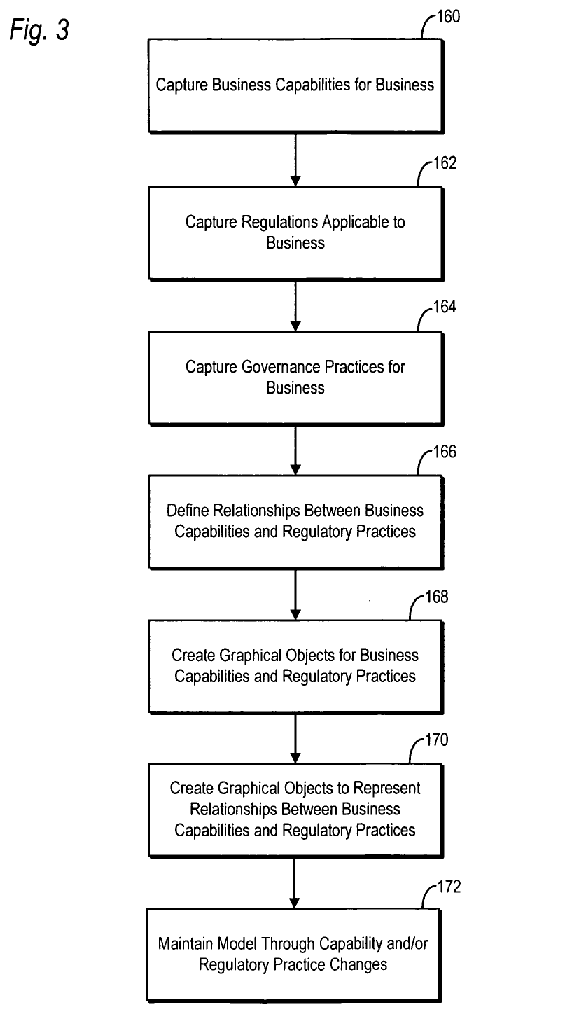

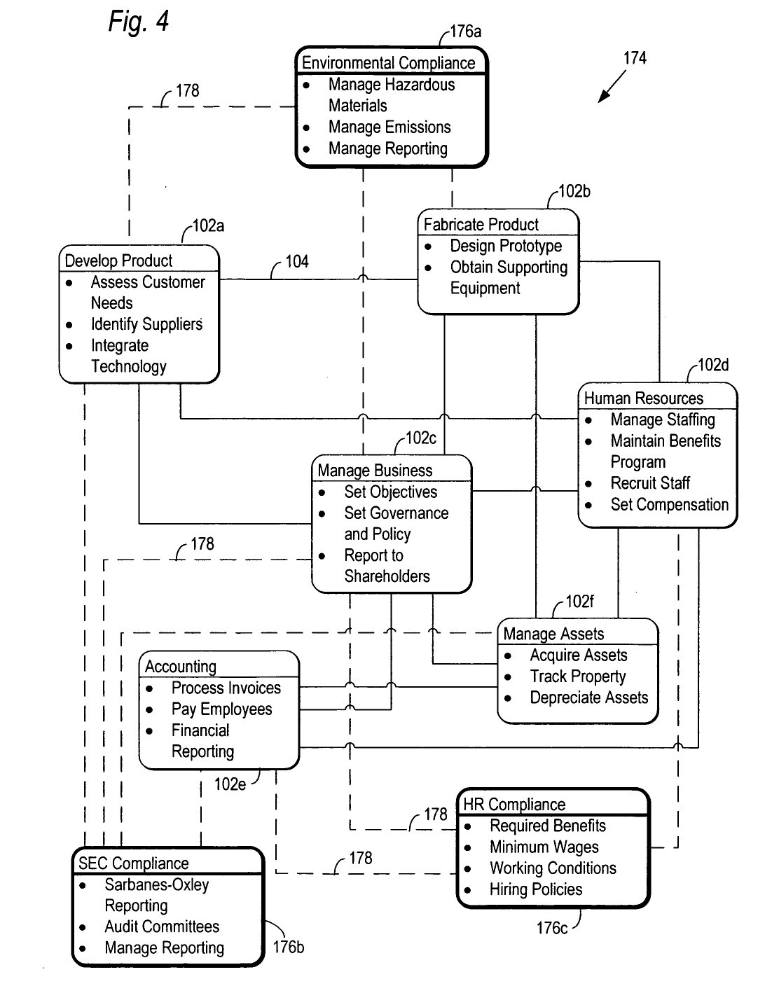

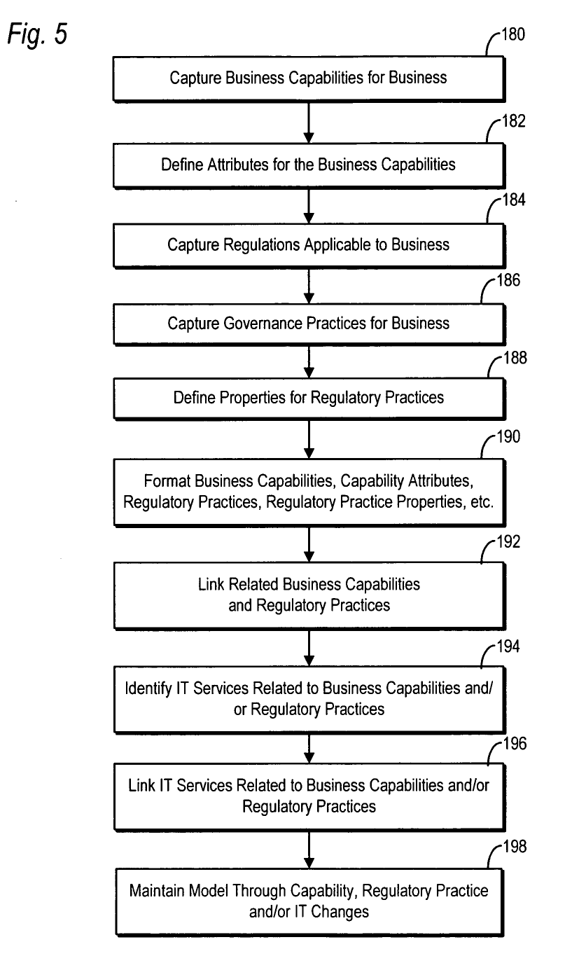

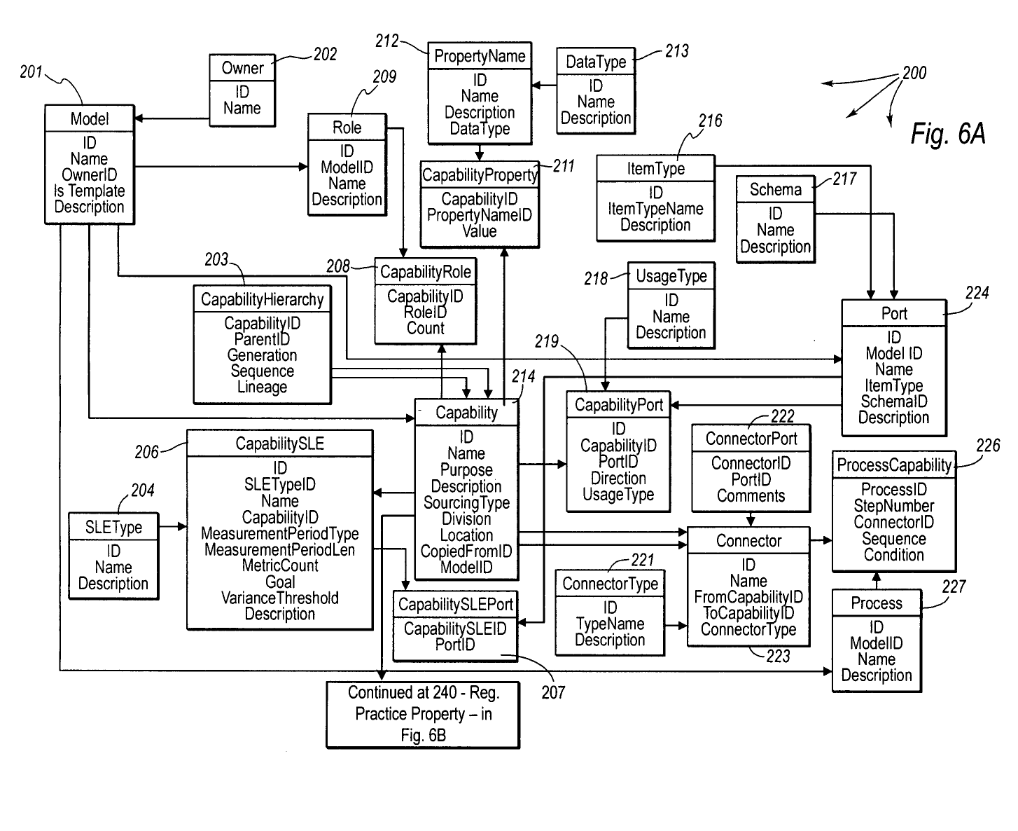

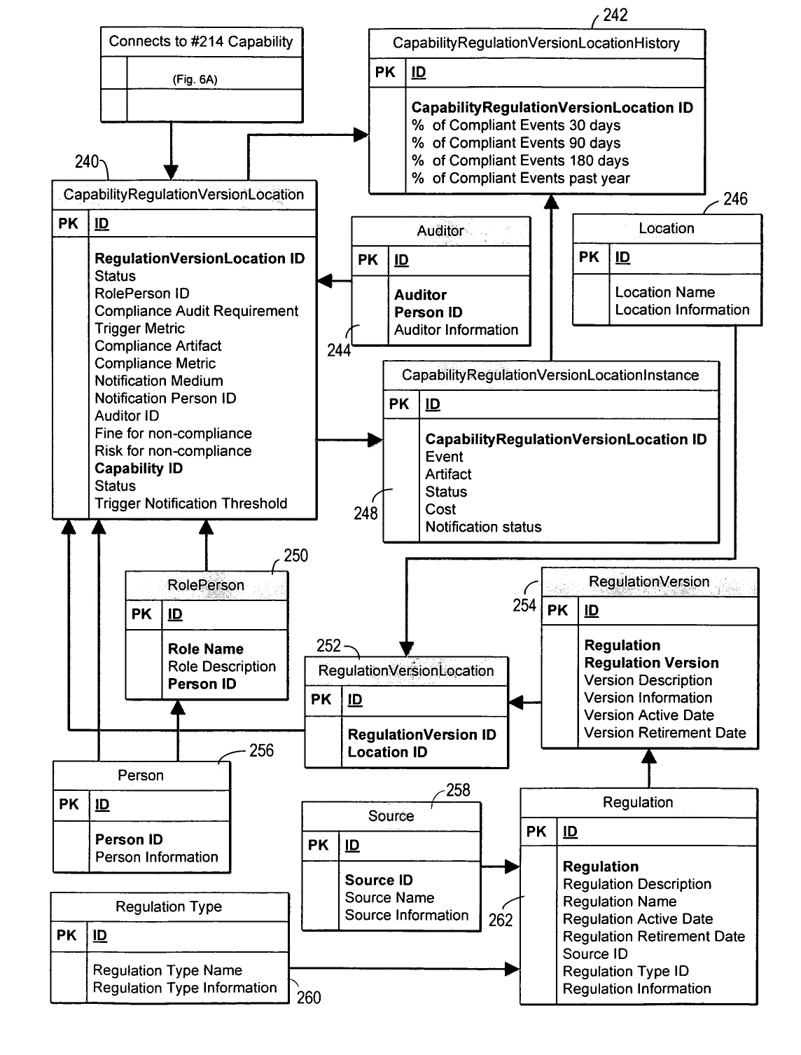

A business architecture including regulatory practices may be a conceptual model, a visual model or a data model. The conceptual model is described below with respect to FIG. 2. The visual model is described below with respect to FIGS. 3 and 4. And the data model is described below with reference to FIGS. 5, 6A and 6B.

FIG. 2 is a flowchart according to an embodiment of the present system for defining a conceptual model of a business including regulatory practices. In accordance with FIG. 2, a first step 150 in forming the conceptual model may involve the capture of all business capabilities of a business as described above. The next steps are to capture all regulatory practices that populate the repository of regulatory practices relevant to a given business. As indicated, this capture of regulatory practices include capturing all regulations that may impact a business (step 152) as well as the internal governance practices for handling the applicable business regulations (step 154). The regulations that may impact a business in step 152 may include, but are not limited to, all international, federal, state, local and business-internal compliance regulations that affect a business, such as for example, wage and labor laws, health and safety laws, environmental laws, tax and tariff regulations, and securities laws such as the Sarbanes-Oxley Act.

As an alternative to capturing the business capabilities and/or regulatory practices in steps 150 through 154, one or more pre-existing templates of business capabilities and/or regulatory practices may have been defined, and a group of the predefined business capabilities and/or regulatory practices may be selected from the template(s) to capture the business capabilities and/or regulatory practices that are applicable to a given business.

The conceptual business model further includes the step 156 of defining all relationships between the business capabilities identified in step 150 and the regulatory practices identified in steps 152 and 154. In general, a business capability and regulatory practice will be related if the regulatory practice impacts the business capability. This may happen a number of ways, such as for example where a certain business capability triggers compliance requirements with any applicable regulatory practice, e.g., use of certain materials may require compliance with environmental laws; hiring employees in a particular state may require compliance with minimum wage and state and federal employment laws; purchase or sale of a particular asset may be considered a material corporate event requiring reporting under the Sarbanes-Oxley Act, etc. A single regulatory practice (whether a regulation or governance practice) may affect, or relate to, multiple business capabilities, and a single business capability may be affected by multiple regulatory practices.

The present system is well suited to capturing changes that occur in the operation of a business. The conceptual model may therefore further include the step 158 of ongoing maintenance of the model. Step 158 reflects the fact that capabilities and/or regulatory practices may change, and that those changes may be easily integrated into the business model.

Embodiments of the present system for defining a visual model of a business including regulatory practices is similar to the conceptual model, but further includes the steps of graphically representing the business capabilities, the regulatory practices and the relationships in between. Thus, referring to the flowchart of FIG. 3, a first step 160 in forming the visual model may involve the capture of the business capabilities of a business as described above.

The next steps are to expose, capture and/or, in some cases, define all regulatory practices that populate the repository of regulatory practices, including all regulations that may impact an organization (step 162) as well as the internal governance practices for handling the applicable business regulations (step 164). Again, as an alternative to capturing the business capabilities and/or regulatory practices in steps 160 through 164, one or more pre-existing templates of business capabilities and/or regulatory practices may have been defined, and a group of the predefined business capabilities and/or regulatory practices may be selected from the template(s) to define the business capabilities and/or regulatory practices that are applicable to a given business. The visual business model further includes the step 166 of defining all relationships between the business capabilities and the regulatory practices.

In step 168, graphical objects may be created within a computing device to represent the business capabilities and regulatory practices. The graphical objects may for example be boxes (or other shapes) labeled with the business capability or regulatory practice. In step 170, graphical objects may be created within a computing device to represent the relationships between the various business capabilities, and between the business capabilities and the regulatory practices. The graphical objects may for example be lines and/or arrows connecting related business capabilities, and related business capabilities and regulatory practices. An arrow into a business capability or regulatory practice may represent an input to the business capability or regulatory practice. Similarly, an arrow out of a business capability or regulatory practice may represent an output from the business capability or regulatory practice. In general, information may flow from the business capabilities to the regulatory practices (i.e., arrows from the business capabilities to the regulatory practices). However, it is understood that information may flow from the regulatory practices to the business capabilities, or two-way communication between the regulatory practices and business capabilities.

Step 172 reflects the fact that capabilities and/or regulatory practices may change, and that those changes may be easily integrated into the visual model of the business architecture.

FIG. 4 is a graphical representation of a business model 174 generated according to the visual model. The business model 174 of FIG. 4 is similar to the business model 100 of FIG. 1, with the addition of the regulatory practices 176 and their relation to the business capabilities 102. Regulatory Practices 176 include “Environmental Compliance” 176a, “Securities and Exchange Commission Compliance” 176b and “Human Resources Compliance” 176c. FIG. 4 further shows a plurality of connections 178 (in dashed lines) between business capabilities 102 that are impacted by particular regulatory practices 176 (albeit high-level ones in this case).

For example, Product Development capability 102a, Manage Business capability 102c, Accounting capability 102e and Manage Assets capability 102f are all impacted by SEC Compliance regulatory practice 176b, and are thus connected to SEC Compliance regulatory practice 176b. In implementation, the capabilities and regulatory practices may be captured at a more detailed level—the explicit regulatory practice may be specifically named, together with a rich set of content describing that regulatory practice at a more detailed level. As a more detailed example, a United States law (enacted as of the time of filing of the application for this patent), set forth at 18 U.S.C. § 1350, sets forth requirements for corporate officers of a business to certify financial reports, as well as penalties for the failure to meet these requirements. In particular, the law sets forth that all corporate reports filed by a business with the Securities Exchange Commission is to be accompanied by a written statement by the chief executive officer and chief financial officer of a business certifying that the report fully complies with the requirements of section 13(a) or 15(d) of the Securities Exchange Act of 1934, and that information contained in the report fairly presents, in all material respects, the financial condition and results of operations of the business. The law further states that any chief executive officer or chief financial officer who files a report known not to be correct is to be fined up to $1,000,000 or imprisoned up to 10 years, or both.

Accordingly, a more detailed graphical representation of a business model than shown in FIG. 4 may include the regulation codified in 18 U.S.C. § 1350, and connections to all business capabilities affected by the law (for example Manage Business capability 102c, Accounting capability 176e, or other more detailed capabilities relating to these general capabilities.

As with FIG. 1, a map for a typical business may include many more business capabilities 102, regulatory practices 176 and connections 104, 178 than shown in FIG. 4. Moreover, it is understood that the business capabilities 102 and regulatory practices 176 may have other and different relations to each other in different business models. The business map 174 of FIG. 4 is illustrated for ease of explanation.

Embodiments of the present system for generating a data model of a business architecture including its regulatory practices will now be explained with reference to FIGS. 5, 6A and 6B. The data model provides a powerful operational view of a business. In embodiments, once set up, the model itself can monitor and manage some or all aspects of a business' regulatory practices in an automated manner. For example, the model may be integrated with a business' IT architecture, as explained hereinafter, to provide notifications, for example in the form of emails, when an event occurs requiring some action be taken to comply with an applicable regulatory practice. Such a data model provides significant advantages over a system relying on business personnel to remain in compliance with applicable regulations, where human error may often lead to a business unknowingly being in noncompliance and subject to fines or other penalties. While this does not prevent that human error, it offers a much more structured way to help prevent it.

Moreover, hypothetical scenarios and changes to a business may be explored through the data model to determine the effect those scenarios and changes would have on the business without having to affect the actual changes. For example, an event may require some action be taken to comply with an applicable regulation. The data model can show the cost associated with complying with the regulation, as well as the penalties, if any, for not complying. Additionally, the data model may easily represent the effects of changes made to a business in order to conform to established best business practices. Thus, a business can easily evaluate whether the established best business practice would in actuality be beneficial to the business. The flexibility of the data model also allows for exception handling, where a parameter of the business is changed in an isolated instance before returning to normal business operations.

Referring now to FIG. 5, there is shown a flowchart for generating a data model of a business architecture including its regulatory practices. A first step 180 in forming the data model may involve the capture of all business capabilities of a business as described above. The business capabilities may alternatively be selected from pre-existing templates as described above. In a step 182, one or more business capability attributes may be defined for each of the business capabilities described in step 180. The definition of business capability attributes is described above and in the previously-incorporated patent applications.

The next steps are to capture all regulatory practices that populate the repository of stand-alone regulatory practices, including all regulations that may impact a business (step 184) as well as the internal governance practices for handling the applicable business regulations (step 186). The regulatory practices may alternatively be selected from pre-existing templates as described above.

In a step 188, one or more regulatory practice properties may be defined for each of the regulatory practices described in steps 184 and 186. The regulatory practice properties describe characteristics and parameters of the regulatory practices, and are analogous to the capability attributes for the business capabilities. Examples, but by no means a complete listing, of regulatory practice properties for a given regulatory practice include:
One or more properties to indicate the degree to which a regulatory practice does or does not regularly materially impact the financial performance of the business, for which the valid values may be along the lines of never, rarely, and often;
One or more properties for the threshold for notification of a regulatory practice performance variance or material performance impact potential;
One or more properties serving as counters for monthly, quarterly, and annual counts for the time the regulatory practice has impacted performance of the business;
One or more properties to capture the person(s) who are responsible for the regulatory practice and/or whom to notify when there is an event requiring notification;
One or more properties indicating the version of a regulation (each time the regulation changes, it is given a new version number);
One or more properties indicating the geographic location where the regulation is applicable, when relevant;
One or more properties indicating the source of the regulation, such as internal governance, an environmental compliance legislation, a tax compliance legislation, etc.);
One or more properties indicating the type of the regulation (such as internal governance, or externally driven law or regulation);
One or more properties indicating the action to be taken for internal governance;
One or more properties indicating the action to be taken for external compliance;
One or more properties indicating the financial action or tax to pay, if any related to the compliance of the regulatory practice;
One or more properties indicating the reporting and/or notification required when an event requires a notice (for example, some securities legislation requires that a publicly traded organization file reports at specific intervals related to the calendar and to their fiscal year);
One or more properties specifying behavior or preventative action to be taken to comply with a regulation;
One or more properties indicating how work is to be done to comply with environmental regulations (e.g., waste disposal);
One or more properties indicating the action to be taken in the event of a physical security violation;
One or more properties indicating the action to be taken in the event of a data or IT security violation;
One or more properties indicating the effective date of a regulatory practice;
One or more properties indicating the effective date of an event triggering a compliance action;
One or more properties indicating the cost of compliance (per event/activity of the regulatory practice);
One or more properties indicating the cost of non-compliance (per event/activity of the regulatory practice);
One or more properties indicating the business risk of non-compliance (if a business capability is not compliant with the specific regulatory practice, what is the risk to the business in terms of fines or penalties—may be in terms of high, medium or low, and it may be specifically quantified);
One or more properties indicating whether or not a regulatory practice is being complied with (may be in terms of yes or no);
One or more properties indicating the person to notify about non-compliance (may or may not be the same person who is notified about compliance);
One or more properties indicating the notification medium for non-compliance (email, facsimile, telephone call, mail, in person notification, other);
One or more properties indicating whether there is a compliance audit requirement (Yes/No);
One or more properties indicating the compliance auditor name, if any;
One or more properties indicating whether regulatory practice compliance was reviewed and signed by auditor, if any;
One or more properties indicating the percentage of compliant and/or noncompliant events in the past 30 days, or other period of time that may be more relevant to the business or to the specific regulation;
One or more properties indicating the percentage of compliant and/or noncompliant events in the past 90 days, or other period of time that may be more relevant to the business or to the specific regulation;
One or more properties indicating the percentage of compliant and/or noncompliant events in the past 180 days, or other period of time that may be more relevant to the business or to the specific regulation;
One or more properties indicating the percentage of compliant and/or noncompliant events in the past 270 days, or other period of time that may be more relevant to the business or to the specific regulation;
One or more properties indicating the percentage of compliant and/or noncompliant events in the past 360 days, or other period of time that may be more relevant to the business or to the specific regulation;
One or more properties indicating the trigger metric; that is, the event which triggers that an action needs to be taken in order to comply under the regulatory practice (may be subjective—e.g., reporting of a “material” event, or may be objective—e.g., paying a tax by a specific date);
One or more properties indicating the compliance metric—i.e., the action that was in fact taken for compliance (as distinguished from the action that was supposed to be taken for compliance) and the measure of that action;
One or more properties indicating the existence of a compliance artifact (a document or form that was filed in the process of being compliant);
One or more properties indicating whether the compliance artifact was filed with the appropriate governance or regulatory body;
One or more properties indicating when the compliance artifact was filed.

The data model of a business architecture further includes the step 190 of formatting each of the business capabilities and capability attributes, as well as each of the regulatory practices and regulatory practice properties, according to one or more selected schemas. A system for selecting the one or more schemas to apply to a particular data model are described in greater detail in the above-incorporated patent applications. As used herein, a “schema” may be defined as an expression of a shared vocabulary between a plurality of computer systems or modules that allow the plurality of computer systems or modules to process data according to the expressed shared vocabulary. A schema can define and describe classes of data using constructs (e.g., name/value pairs) of a schema language. The schema constructs can be used to constrain and document the meaning, usage, and relationships of data types, elements and their content, attributes/properties and their values, entities and their contents, and notations, as used in a specified application, such as, for example, a business capability model. Thus, any computer system or module that can access a schema can process data in accordance with the schema. Further, any computer system or module that can access a schema can compose or modify data for use by other computer systems and/or modules that can also access the schema.

A schema can be utilized to define virtually any data type including logical, binary, octal, decimal, hexadecimal, integer, floating-point, character, character string, user-defined data types, and combinations of these data types used to define data structures. Some examples of user-defined data types are business capability attributes, regulatory practice properties, business capability/regulatory practice inputs and outputs, business capability/regulatory practice processes and business capability/regulatory practice connections. A data type can also be defined to reference or link to other data types in a schema hierarchy.

An extensible Markup Language (“XML”) schema is one example of a type of schema. An XML schema can define and describe a class of XML documents using schema constructs (e.g., name/value pairs) of an XML schema language. These schema constructs can be used to constrain and document the meaning, usage, and relationships of data types, elements and their content, attributes and their values, entities and their contents, and notations, as used in XML documents. Thus, schema is also defined to include Document Type Definitions (“DTD”), such as, for example, DTD files ending with a “.dtd” extension and World Wide Web Consortium (“W3C”) XML Schemas, such as for example, XML Schema files ending with an “.xsd” extension. However, the actually file extension for a particular DTD or XML schema is not important.

A computing device may include a software module for formatting the business capabilities, capability attributes, regulatory practices, regulatory practice properties, etc. in accordance with a selected schema. For example, the formatting module can format a “fixed cost allocation” attribute/property to be of a currency data type based on data definitions set forth in a schema.

FIGS. 6A and 6B illustrate an example business capability modeling schema 200 that can be used for efficient and flexible business modeling based upon defined business capabilities and regulatory practices. It should be understood that business capability modeling schema 200 can be one of a plurality of schemas that includes data definitions for modeling a corresponding plurality of different business capabilities, capability attributes, regulatory practices, regulatory practice properties, etc.

Depicted in FIG. 6A, schema 200 includes model data format 201. Generally, model data format 201 can be described as indicated in Table 1.

TABLE 1

| | Data | |
|---|---|---|
| Name | Type | Description |
| ID | Int | Key to the model and is used to relate |
| | | other data entities to this model. |
| Name | varchar(150) | A unique name that identifies the model. |
| OwnerID | Int | Points to the owner of the model. An |
| | | owner can own many models. |
| IsTemplate | Bit | Controls the ability of a modeler to |
| | | modify this model. If this field is |
| | | true, it means that this model is to |
| | | be used as a template for other models |
| | | and can thus be used to compare the |
| | | derived models, even after properties |
| | | are changed by modelers in the |
| | | derived models. Therefore, this model |
| | | cannot be changed by normal editors |
| | | of models. Defaults to false. |
| Description | varchar(2000) | Textual description of the model. |

Depicted in FIG. 6A, schema 200 includes owner data format 202. Generally, owner data format 202 can be described as indicated in Table 2.

TABLE 2

| | Data | |
|---|---|---|
| Name | Type | Description |
| ID | Int | Key to the owner and is used to |
| | | relate other data entities to this owner. |
| Name | Varchar(50) | Unique name of the owner. |

Depicted in FIG. 6A, schema 200 includes capability data format 214. Generally, capability data format 214 can be described as indicated in Table 3.

TABLE 3

| | Data | |
|---|---|---|
| Name | Type | Description |
| ID | Int | Key to the capability and is used to |
| | | relate other data entities to this |
| | | capability. |
| Name | varchar(256) | Name that is unique within a particular |
| | | model. |
| Purpose | varchar(1000) | Short description of the capability. |
| Description | varchar(8000) | A more detailed description of the |
| | | capability and may explain relationships |
| | | and properties of this capability as |
| | | well as the capability itself. |
| SourcingType | Int | This field can have three values: |
| | | Internal, Outsourced, or Both. It |
| | | indicates whether or not the |
| | | capability is performed by an |
| | | organization that is internal (part |
| | | of the organization that “owns” |
| | | the model); or an organization |
| | | that is a supplier of the capability |
| | | to the “owner” of the model; or |
| | | it is performed by both internal and |
| | | external suppliers. |
| Division | varchar(100) | Identifies the business organizational |
| | | area where a capability is performed. |
| Location | varchar(100) | Geographical location where the |
| | | capability is performed. |
| CopiedFromID | Int | Indicates the specific capability (and |
| | | hence template model) from which this |
| | | capability was copied. Can be a |
| | | system-set value. |
| ModelID | Int | Indicates the model to which this |
| | | capability belongs. |

Depicted in FIG. 6A, schema 200 includes capability hierarchy data format 203. Generally, capability hierarchy data format 203 can be described as indicated in Table 4.

TABLE 4

| | Data | |
|---|---|---|
| Name | Type | Description |
| CapabilityID | Int | Links to a capability. |
| ParentID | Int | Links to a capability in the same model |
| | | and indicates the parent of this capability |
| | | in a hierarchical view of the model's |
| | | capabilities. |
| Generation | Int | Part of the lineage key which is used in |
| | | certain queries. |
| Sequence | Int | Part of the lineage key which is used in |
| | | certain queries. |
| Lineage | varchar(20) | Indicates the entire ancestral lineage of a |
| | | capability and used to perform |
| | | hierarchical sorts. |

Depicted in FIG. 6A, schema 200 includes capability property data format 211. Generally, capability property data format 211 can be described as indicated in Table 5.

TABLE 5

| | Data | |
|---|---|---|
| Name | Type | Description |
| CapabilityID | Int | Links to a capability. |
| PropertyNameID | Int | Links to a user-defined property. |
| Value | varchar(250) | Value of the property for this |
| | | capability. |

Depicted in FIG. 6A, schema 200 includes property name data format 212. Generally, property name data format 212 can be described as indicated in Table 6.

TABLE 6

| | Data | |
|---|---|---|
| Name | Type | Description |
| ID | Int | Key to the property and is used to |
| | | relate this property to capabilities. |
| Name | varchar(250) | Name of the property and is user |
| | | defined. |
| Description | varchar(4000) | Description of what the property is and |
| | | how it is to be used to describe |
| | | capabilities. |
| DataType | Int | Links to the DataType entity and |
| | | indicates the type of data that is |
| | | expected when a modeler sets a value |
| | | for this property for a capability. |
| | | If, for example, the modeler defines a |
| | | property named “Fixed Cost |
| | | Allocation”, it is likely that the |
| | | data type for this property would be |
| | | “Currency”. |

Depicted in FIG. 6A, schema 200 includes data type data format 213. Generally, data type data format 213 can be described as indicated in Table 7.

TABLE 7

| | Data | |
|---|---|---|
| Name | Type | Description |
| ID | Int | Key to the data type and is used to |
| | | indicate the data type of a user defined |
| | | property. This is one of a few tables |
| | | that we assume are not modified by |
| | | modelers as the modeling tools rely on |
| | | the values being “known” in order to |
| | | perform validations of property values |
| | | correctly. |
| Name | varchar(20) | A friendly name of the data type. |
| | | Examples are “Integer”, “String”, |
| | | “Currency”, etc. |
| Description | varchar(4000) | Any additional information about the |
| | | data type that would be useful |
| | | especially in guiding user selection of |
| | | data types for the properties that they |
| | | define. |

Depicted in FIG. 6A, schema 200 includes port data format 224. Ports corresponding to a business capability and/or regulatory practice can be used to transfer input into and output out of the corresponding business capability/regulatory practice. Generally, port data format 224 can be described as indicated in Table 8.

TABLE 8

| | Data | |
|---|---|---|
| Name | Type | Description |
| ID | Int | Key to the port and is used to relate this |
| | | port to other entities. |
| ModelID | Int | Indicates that this port belongs to the |
| | | related model. When dealing with a |
| | | particular model, only the ports |
| | | associated with the model are available |
| | | to the modeler. A port is something that |
| | | is input to - consumed by - a capability |
| | | or output from - produced by - a |
| | | capability. |
| Name | varchar(256) | A unique name within the specific |
| | | model. |
| ItemType | Int | Links to the ItemType entity which |
| | | indicates the type of input or output, |
| | | which could be electronic data, a |
| | | physical item, a fax, an event, etc. |
| SchemaID | Int | If the ItemType indicates that this is an |
| | | electronic data record of some kind, this |
| | | field links to the schema that describes |
| | | the content of the data record. |
| Description | varchar(4000) | A detailed description of the |
| | | input/output item. |

Depicted in FIG. 6A, schema 200 includes capability port data format 219. Generally, capability port data format 219 can be described as indicated in Table 9.

TABLE 9

| | Data | |
|---|---|---|
| Name | Type | Description |
| ID | Int | Key to the capability port and is used to |
| | | relate this port to other entities. |
| CapabilityID | Int | Links to the capability that is referenced |
| | | by this relationship. |
| PortID | Int | Links to the port that is referenced by |
| | | this relationship. |
| Direction | Int | Has three values and indicates whether |
| | | or not the item is input into the |
| | | referenced capability, output from the |
| | | referenced capability, or it flows both |
| | | directions. |
| UsageType | Int | Links to the UsageType entity and |
| | | indicates how the capability uses this |
| | | item. Examples are “Read only”, |
| | | “Read and update”, “Create”, etc. |

Depicted in FIG. 6A, schema 200 includes usage type data format 218. Generally, usage type data format 218 can be described as indicated in Table 10.

TABLE 10

| | Data | |
|---|---|---|
| Name | Type | Description |
| ID | Int | Key to the UsageType and is used to |
| | | relate this usage type to the input/output |
| | | items (port entity). This table is |
| | | assumed to be non-modifiable by |
| | | modelers as the tools rely on its specific |
| | | values to process models. |
| Name | varchar(150) | A unique name that identifies the usage |
| | | type. Examples include “Read only”, |
| | | “Read and update”, “Create”, etc. |
| Description | varchar(4000) | A more detailed description of the |
| | | usage type and how the modeling tools |
| | | may behave when dealing with a |
| | | specific usage type. |

Depicted in FIG. 6A, schema 200 includes item type data format 216. Generally, item type data format 216 can be described as indicated in Table 11.

TABLE 11

| | Data | |
|---|---|---|
| Name | Type | Description |
| ID | Int | Key to the ItemType and is used to |
| | | relate this item type to the |
| | | input/output items (port entity). |
| | | This table is assumed to be |
| | | non-modifiable by modelers as the |
| | | tools rely on its specific |
| | | values to process models. |
| ItemTypeName | varchar(150) | A unique name that identifies the usage |
| | | type. Examples include “Electronic |
| | | data”, “Physical item”, “Fax”, etc. |
| Description | varchar(4000) | A more detailed description of the item |
| | | type and how the modeling tools may |
| | | behave when dealing with a specific |
| | | item type. |

Depicted in FIG. 6A, schema 200 includes schema data format 217. Generally, schema data format 217 can be described as indicated in Table 12.

TABLE 12

| | Data | |
|---|---|---|
| Name | Type | Description |
| ID | Int | This is the key to the Schema entity and |
| | | is used to relate this item type to the |
| | | input/output items (port entity). |
| Name | varchar(250) | This is a unique name for a schema. |
| Description | varchar(4000) | This may be a detailed description of |
| | | the data content for a data record in the |
| | | form of an XML schema (or some |
| | | simplification thereof). |

Depicted in FIG. 6A, schema 200 includes process data format 227. Generally, process data format 227 can be described as indicated in Table 13.

TABLE 13

| | Data | |
|---|---|---|
| Name | Type | Description |
| ID | Int | Key to the Process entity and is used to |
| | | relate this item type to connector |
| | | entities, and through them to the related |
| | | capabilities in the ProcessCapability |
| | | entity. |
| ModelID | Int | Indicates the model that these |
| | | processes belong to. |
| Name | varchar(256) | A unique name for a process within this |
| | | model. |
| Description | varchar(4000) | Describes the process that is modeled |
| | | by this entity and the ProcessCapability |
| | | entities. |

Depicted in FIG. 6A, schema 200 includes process capability data format 227. Generally, process capability data format 227 can be described as indicated in Table 14.

TABLE 14

| | Data | |
|---|---|---|
| Name | Type | Description |
| ProcessID | Int | Indicates the process that this |
| | | capabilities and connections belong to. |
| StepNumber | Int | Indicates the sequence of this |
| | | connection in the process and is used |
| | | to sort the process steps for rendering |
| | | in a visual model. |
| ConnectorID | Int | Links to the Connector entity and |
| | | through it to the source and target |
| | | capabilities of a process flow from a |
| | | source capability to a destination |
| | | capability. |
| Sequence | Int | Indicates the sequence of a connection |
| | | within a step, thereby supporting |
| | | process flows that have multiple paths |
| | | through it. To define a path where one |
| | | leg has more steps (or flows through |
| | | more capabilities) than another leg, the |
| | | shorter leg is represented by entries in |
| | | this table that reference the same |
| | | connector but different StepNumbers. |
| Condition | varchar(4000) | Stores comments on what the |
| | | conditions are that drive the process. |

Depicted in FIG. 6A, schema 200 includes connector data format 223. Generally, connector data format 223 can be described as indicated in Table 15.

TABLE 15

| | Data | |
|---|---|---|
| Name | Type | Description |
| ID | Int | Key to the Connector entity and |
| | | indicates the connection between |
| | | two capabilities. This key is |
| | | used to link this connection to |
| | | other entities. |
| Name | varchar(256) | A comment that is associated with |
| | | this connection between two |
| | | capabilities. |
| FromCapabilityID | Int | References the capability that is |
| | | the source capability. Depending |
| | | on the ConnectorType, the meaning |
| | | of being the source capability may |
| | | differ slightly. |
| ToCapabilityID | Int | References the capability that is |
| | | the target capability. Depending |
| | | on the ConnectorType, the meaning |
| | | of being the target capability may |
| | | differ slightly. |
| ConnectorType | Int | Link to the ConnectorType entity |
| | | and indicates what the relationship |
| | | between the two referenced |
| | | capabilities really means. |
| | | Examples, are “Collaborative”, |
| | | “Controlling”, “Dependent”, |
| | | etc. |

Depicted in FIG. 6A, schema 200 includes connector type data format 221. Generally, connector type data format 221 can be described as indicated in Table 16.

TABLE 16

| | Data | |
|---|---|---|
| Name | Type | Description |
| ID | Int | Key to the ConnectorType entity and is |
| | | used to describe the connection type in |
| | | the Connector entity. |
| TypeName | varchar(50) | A unique name that describes the type of |
| | | connection. Examples are |
| | | “Collaborative”, “Controlling”, |
| | | “Dependent”, etc. |
| Description | varchar(4000) | A detailed description of the connection |
| | | type and helps modelers understand what |
| | | connections mean in their models. |

Depicted in FIG. 6A, schema 200 includes connector port data format 222. Generally, connector port data format 222 can be described as indicated in Table 17.

TABLE 17

| | Data | |
|---|---|---|
| Name | Type | Description |
| ConnectorID | Int | A reference to the Connector entity and |
| | | serves to link a specific connection |
| | | between two capabilities with a specific |
| | | input/output item. |
| PortID | Int | A reference to the Port entity |
| | | (input/output item) and serves to identify |
| | | the input/output item that flows along a |
| | | specific connection. |
| Comments | varchar(4000) | More detailed commentary about the flow |
| | | of an item along this connection. |

Depicted in FIG. 6A, schema 200 includes role data format 209. Generally, role data format 209 can be described as indicated in Table 18.

TABLE 18

| | Data | |
|---|---|---|
| Name | Type | Description |
| ID | Int | Key to the Role entity and is used to |
| | | relate this role to Capability entities. |
| ModelID | Int | Indicates what model this role entity |
| | | belongs to. |
| Name | varchar(100) | A unique name for the role within this |
| | | model. A role describes a type of |
| | | person or user involved in performing |
| | | capabilities. |
| Description | varchar(2000) | Provides a description of the role and |
| | | may provide guidance to modelers in |
| | | their choice of roles to associate with |
| | | capabilities. |

Depicted in FIG. 6A, schema 200 includes capability role data format 208. Generally, capability role data format 208 can be described as indicated in Table 19.

TABLE 19

| | Data | |
|---|---|---|
| Name | Type | Description |
| CapabilityID | Int | References a specific capability and |
| | | serves to link that capability with a |
| | | specific role. |
| RoleID | Int | References a specific role and links it |
| | | to the referenced capability. |
| Count | Int | Indicates the number of people in this |
| | | role that are required to perform this |
| | | capability. A value of ‘0’ indicates |
| | | that the role participation has not been |
| | | quantified. |

Depicted in FIG. 6A, schema 200 includes service level expectation (“SLE”) type data format 204. Generally, SLE type data format 204 can be described as indicated in Table 20.

TABLE 20

| | Data | |
|---|---|---|
| Name | Type | Description |
| ID | Int | Key to the SLEType entity and is used to |
| | | relate this role to CapabilitySLE entities. |
| Name | varchar(100) | Uniquely names the type of service level |
| | | that is described in this entity. This |
| | | entity is assumed to be read-only by |
| | | modelers because the modeling tools rely |
| | | on the value of these entries to |
| | | visualize service levels. Some values |
| | | for service level types include |
| | | “Duration”, “Throughput”, |
| | | “Monetary Cost”, “Time Cost” |
| | | and “Concurrency”. |
| Description | varchar(4000) | A detailed description of the service level |
| | | type and how to describe specific service |
| | | levels related to capabilities. |

Depicted in FIG. 6A, schema 200 includes Capability SLE data format 206. Generally, Capability SLE data format 206 can be described as indicated in Table 21.

TABLE 21

| | Data | |
|---|---|---|
| Name | Type | Description |
| ID | Int | Key to the Capability |
| | | SLE entity and is used |
| | | to relate this entity |
| | | to Capability entities. |
| SLETypeID | Int | References the SLEType |
| | | entity and identifies |
| | | a specific way to measure |
| | | a service level. |
| Name | Varchar(50) | A unique name for the |
| | | service level definition. |
| CapabilityID | Int | References the capability |
| | | to which this service |
| | | level applies. |
| MeasurementPeriodType | Varchar(50) | Names the unit of measure |
| | | for the service level. For |
| | | “Duration” type |
| | | service levels, this |
| | | should be a time period. |
| | | For a “Monetary Cost” |
| | | SLE type, “Dollars” or |
| | | “Thousands of dollars” |
| | | would be appropriate. |
| MeasurementPeriodLen | Int | If the SLE type references |
| | | a “Throughput” type |
| | | of SLE, this field |
| | | indicates the length of |
| | | the measurement period for |
| | | throughput. |
| MetricCount | Int | An actual (current |
| | | status/performance or |
| | | historical performance) |
| | | measurement of the SLE, |
| | | such as the number of days |
| | | of duration, the number |
| | | of items completed for |
| | | throughput, the amount |
| | | of dollars for monetary |
| | | cost, etc. |
| Goal | Int | A target for future |
| | | performance such as the |
| | | number of days of duration, |
| | | the number of items |
| | | completed for throughput, |
| | | the amount of dollars for |
| | | monetary cost, etc. |
| VarianceThreshold | Int | How much variation in |
| | | performance (e.g., from |
| | | a goal) is tolerated |
| | | before a variation is |
| | | noted or notification is |
| | | sent. For example, when a |
| | | variance threshold is |
| | | exceeded, an electronic |
| | | mail message can be sent |
| | | to appropriate management |
| | | personnel |
| Description | Varchar(2000) | A detailed description |
| | | of the SLE for this |
| | | capability. |

Depicted in FIG. 6A, schema 200 includes Capability SLE Port data format 207. Generally, Capability SLE port data format 207 can be described as indicated in Table 22.

TABLE 22

| | Data | |
|---|---|---|
| Name | Type | Description |
| CapabilitySLEID | Int | References a particular service level |
| | | for a specific capability as described |
| | | in a CapabititySLE entity. It serves to |
| | | link a particular service level to a |
| | | particular input or output item. |
| PortID | Int | References a particular input or |
| | | output item of a capability and links a |
| | | service level to the specific item that |
| | | is being measured. For example, this |
| | | might reference mortgage approvals |
| | | for a duration service level for a |
| | | mortgage processing capability and |
| | | the entire service level definition might |
| | | thereby describe that 100 mortgage |
| | | approvals are completed every day |
| | | for the mortgage processing |
| | | capability. |

FIG. 6B is a continuation of FIG. 6A, showing the data format for the regulatory practices. Depicted in FIG. 6B, schema 200 further includes a data format 240 for a regulatory practice property version location. Generally, regulatory practice property version location data format 240 can be described as indicated in Table 23.

TABLE 23

| | Data | |
|---|---|---|
| Name | Type | Description |
| ID | Int | |
| RegulationVersionLocation | Int | |
| ID | | |
| Status | varchar(1000) | |
| RolePerson ID | Int | Links the person |
| | | performing this role |
| | | to this regulatory |
| | | practice |
| Compliance Audit | varchar(1000) | The audit required for |
| Requirement | | compliance with the |
| | | regulatory practice |
| Trigger Metric | varchar(1000) | As indicated above, the |
| | | event which triggers |
| | | that an action needs to |
| | | be taken in order to |
| | | comply under the |
| | | regulatory practice |
| Compliance Artifact | varchar(500) | As indicated above, a |
| | | document or form that |
| | | is filed in the process |
| | | of being compliant |
| Compliance Metric | varchar(1000) | As indicated above, the |
| | | measure of the action |
| | | that was in fact |
| | | taken for compliance |
| Notification Medium | varchar(100) | As indicated above, the |
| | | medium used for |
| | | notification, i.e., |
| | | email, telephone call, |
| | | facsimile, etc. |
| Notification Person ID | Int | Links the person |
| | | receiving notification |
| | | to this regulatory |
| | | practice |
| Auditor ID | Int | Links the person |
| | | performing the audit |
| | | to this regulatory |
| | | practice |
| Fine for non-compliance | Int | The fine for |
| | | non-compliance with |
| | | the regulatory practice |
| Risk for non-compliance | varchar(1000) | The risk of non compliance |
| Capability ID | Int | The capability to which |
| | | the regulatory practice |
| | | is linked |
| Status | varchar(1000) | The status of the |
| | | regulatory practice as |
| | | attached to the |
| | | particular capability |
| Trigger Notification | Int | How much variation in |
| Threshold | | performance is tolerated |
| | | before a variation is |
| | | noted or notification is |
| | | sent. For example, when a |
| | | variance threshold is |
| | | exceeded, an electronic |
| | | mail message can |
| | | be sent to appropriate |
| | | management personnel |

Depicted in FIG. 6B, schema 200 further includes a data format 242 for a regulatory practice property version location history. Generally, regulatory practice property version location history data format 242 can be described as indicated in Table 24.

TABLE 24

| | Data | |
|---|---|---|
| Name | Type | Description |
| ID | Int | |
| CapabilityRegulationVersionLocation | Int | |
| ID | | |
| % of Compliant Events 30 days | Int | The percentage of |
| | | compliant events |
| | | occurring in the past 30 |
| | | days, or other period of |
| | | time that may be more |
| | | relevant to the business |
| | | or to the specific |
| | | regulation |
| % of Compliant Events 90 days | Int | The percentage of |
| | | compliant events |
| | | occurring in the past 90 |
| | | days, or other period of |
| | | time that may be more |
| | | relevant to the business |
| | | or to the specific |
| | | regulation |
| % of Compliant Events 180 days | Int | The percentage of |
| | | compliant events |
| | | occurring in the past 180 |
| | | days, or other period of |
| | | time that may be more |
| | | relevant to the business |
| | | or to the specific |
| | | regulation |
| % of Compliant Events past year | Int | The percentage of |
| | | compliant events |
| | | occurring in the past |
| | | year, or other period of |
| | | time that may be more |
| | | relevant to the business |
| | | or to the specific |
| | | regulation |

Depicted in FIG. 6B, schema 200 further includes a data format 244 for a regulatory practice auditor. Generally, regulatory practice auditor data format 244 can be described as indicated in Table 25.

TABLE 25

| | Data | |
|---|---|---|
| Name | Type | Description |
| ID | Int | |
| Auditor | varchar(100) | Name of the person responsible |
| | | for performing an audit |
| Person ID | Int | Identifier for a specific person |
| Auditor Information | varchar(1000) | A more detailed description of |
| | | the auditor. |

Depicted in FIG. 6B, schema 200 further includes a data format 246 for a regulatory practice location. Generally, regulatory practice location data format 246 can be described as indicated in Table 26.

TABLE 26

| | Data | |
|---|---|---|
| Name | Type | Description |
| ID | Int | |
| Location Name | varchar(100) | Unique name of the location. |
| Location Information | varchar(1000) | A more detailed description of |
| | | the location. |

Depicted in FIG. 6B, schema 200 further includes a data format 248 for a regulatory practice version location instance. Generally, regulatory practice version location instance data format 248 can be described as indicated in Table 27.

TABLE 27

| | Data | |
|---|---|---|
| Name | Type | Description |
| ID | Int | |
| CapabilityRegulationVersionLocation | Int | |
| ID | | |
| Event | varchar(500) | A description of the event |
| | | giving rise to the need for |
| | | some compliance action to |
| | | be taken |
| Artifact | varchar(500) | A document or form that is |
| | | filed in the process of |
| | | being compliant |
| Status | varchar(1000) | The status of the regulation |
| | | in the Location |
| Cost | Int | The cost of compliance |
| | | triggered by the event |
| Notification Status | varchar(1000) | Indication of whether anyone |
| | | has been notified for the |
| | | compliance activities |

Depicted in FIG. 6B, schema 200 further includes a data format 250 for a regulatory practice role person. Generally, regulatory practice role person data format 250 can be described as indicated in Table 28.

TABLE 28

| | Data | |
|---|---|---|
| Name | Type | Description |
| ID | Int | |
| Role Name | varchar(100) | Unique name of the Role. |
| Role Description | varchar(5000) | A more detailed description of the |
| | | Role and may explain relationships |
| | | and properties of this Role as well as |
| | | the Role itself. |
| Person ID | Int | A specific person in the role |

Depicted in FIG. 6B, schema 200 further includes a data format 252 for a regulatory practice version location. Generally, regulatory practice property data version location 252 can be described as indicated in Table 29.

TABLE 29

| | Data | |
|---|---|---|
| Name | Type | Description |
| ID | Int | |
| RegulationVersion ID | Int | Linking the regulation version to |
| | | the location of the regulation |
| | | version. |
| Location ID | Int | |

Depicted in FIG. 6B, schema 200 further includes a data format 254 for a regulatory practice version. Generally, regulatory practice version data format 254 can be described as indicated in Table 30.

TABLE 30

| | Data | |
|---|---|---|
| Name | Type | Description |
| ID | Int | |
| Regulation | varchar(500) | Name of the regulation |
| Regulation | varchar(500) | Version of the regulation |
| Version | | |
| Version | varchar(5000) | A more detailed description of the |
| Description | | regulation version and may explain |
| | | history of older versions and changes |
| | | in the current version over the prior |
| | | version. |
| Version | varchar(1000) | A short description of the regulation |
| Information | | version |
| Version | varchar(100) | The date the version became active |
| Active Date | | |
| Version | varchar(100) | The date the version is to be retired |
| Retirement | | |
| Date | | |

Depicted in FIG. 6B, schema 200 further includes a data format 256 for a regulatory practice person. Generally, regulatory practice person data format 256 can be described as indicated in Table 31.

TABLE 31

| | Data | |
|---|---|---|
| Name | Type | Description |
| ID | Int | |
| Person ID | Int | |
| Person Information | varchar(5000) | Description of a specific person |

Depicted in FIG. 6B, schema 200 further includes a data format 258 for a regulatory practice source. Generally, regulatory practice source data format 258 can be described as indicated in Table 32.

TABLE 32

| | Data | |
|---|---|---|
| Name | Type | Description |
| ID | Int | |
| Source ID | Int | |
| Source Name | varchar(100) | Unique name of the Source. |
| Source | varchar(5000) | Other descriptive information about |
| Information | | the Source |

Depicted in FIG. 6B, schema 200 further includes a data format 260 for a regulatory practice type. Generally, regulatory practice type data format 260 can be described as indicated in Table 33.

TABLE 33

| | Data | |
|---|---|---|
| Name | Type | Description |
| ID | Int | |
| Regulation | varchar(100) | Name of the Regulation Type |
| Type Name | | |
| Regulation Type | varchar(5000) | Other descriptive information about |
| Information | | the Regulation Type |

Depicted in FIG. 6B, schema 200 further includes a data format 262 for a regulatory practice. Generally, regulatory practice data format 262 can be described as indicated in Table 34.

TABLE 34

| | Data | |
|---|---|---|
| Name | Type | Description |
| ID | Int | |
| Regulation | varchar(100) | Name of the regulatory practice |
| Regulation | varchar(5000) | A more detailed description of the |
| Description | | regulation and may explain |
| | | relationships and properties of this |
| | | regulation as well as the regulation |
| | | itself. |
| Regulation | varchar(100) | Unique name of the Regulation. |
| Name | | |
| Regulation | varchar(100) | Date the regulatory practice became |
| Active | | effective |
| Date | | |
| Regulation | varchar(100) | Date the regulatory practice is to be, |
| Retirement | | or has been, repealed |
| Date | | |
| Source ID | Int | |
| Regulation | Int | |
| Type ID | | |
| Regulation | varchar(5000) | A short description of the regulatory |
| Information | | practice |

It should be understood that schema 200 is merely one example of a business capability modeling schema. Further, modeling business capabilities and/or regulatory practices do not require that capability attributes or regulatory practice properties for all the data formats in schema 200 be accessible. For example, a capability and connector can be used to model a business capability based on capability data format 214 and connector data format 223, without accessing capability attributes corresponding to other data formats. Thus, schema 200 defines data formats for business capability attributes that are accessed, but does not require that all data formats be populated to generate a business capability model.

Referring again to FIG. 5, after formatting the data for the business capabilities and regulatory practices according to a given schema, those regulatory practices and business capabilities that are related to each other may be linked within the computing system in a known manner to indicate the relationship (step 192).

Additionally, the data model may be integrated with a business' IT architecture, as indicated above, to manage and keep track of regulatory practices, as well as to provide notifications when an event occurs related to the regulatory practices (i.e., some action to be taken to comply with an applicable regulation, some action to be taken to indicate the compliance action has or has not been taken, etc.). IT architecture may include application architecture, information architecture, and technology architecture. Therefore, in step 194, those IT services that relate to the regulatory practices, as well as those IT services that relate to the business capabilities that are impacted by a regulatory practice, are identified. These IT services are those which are in place (or which may be implemented in the IT architecture) that can automate any aspect of monitoring, managing, keeping track of, reporting on and/or implementing a regulatory practice and/or business capability impacted by a regulatory practice.

The result of step 192 is to identify regulatory practices and/or business capabilities that may potentially be automated through the business' IT architecture. For those regulatory practices and/or business capabilities identified in step 194, the next step is to link the regulatory practice properties for any identified regulatory practices, and to link the capability attributes for any identified business capability, to the IT architecture (step 196). This linking step involves integrating the regulatory practice properties and/or capability attributes into the business' administrative, operating and other databases in a known manner so that the business' IT architecture may then monitor, manage, keep track of, report on and/or implement the regulatory practices identified in step 192.

Step 198 reflects the fact that capabilities, regulatory practices and/or IT services may change, and that those changes may be easily integrated into the data model of the business.

Once the links are established in step 196, the ongoing regulatory management of the business and IT architecture will be in place to allow for exception handling and notification (whatever the cause of the exception). Linking to IT services also allows for efficient change management, whether the change comes from the IT architecture or from the performance of the business.

As an example of the operation of the present system, in the case of environmental compliance, when an item is manufactured using a specific material, a form may need to be filed with a designated agency to comply with applicable regulations. Once the regulatory practices are linked to the IT architecture, the IT service may then track the requirement of the form filing, notify the appropriate people when the requirement to file the form arises, track whether or not the appropriate form was filed, track when it was filed, etc.

As a further example, in the case of a securities regulations such as Sarbanes-Oxley, once the regulatory practices are linked to the IT architecture, the IT service may then be able to notify the person if the activity would receive Sarbanes-Oxley treatment (in cases where it's purely a mathematical analysis to determine this). This is so even though the responsible personnel may not be clear on when and under what conditions events require Sarbanes-Oxley attention.

As a further example, in the case of a time based compliance regulation, such as taxes, once the regulatory practices are linked to the IT architecture, the IT service may then provide both proactive and reactive notifications of special events and/or requirements, as well as notification when there is a compliance problem.

In embodiments, the stand-alone repository of regulatory practices may integrate efficiently with the above-described business capability model based on what a business does. However, in alternative embodiments, the regulatory practices described above may instead be used with older “subjective” business models that are based on how a business operates (as described in the Background section). In such embodiments, the regulatory practices according to the present system may still be linked to aspects of the subjective business models to provide a clearer picture of the regulatory practices of the business.

FIG. 7 illustrates an example of a suitable general computing system environment 300 that may comprise any computing device or processing device shown herein on which the inventive system may be implemented. The computing system environment 300 is only one example of a suitable computing environment and is not intended to suggest any limitation as to the scope of use or functionality of the inventive system. Neither should the computing system environment 300 be interpreted as having any dependency or requirement relating to any one or combination of components illustrated in the exemplary computing system environment 300.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 7, an exemplary system for implementing the inventive system includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 may include a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile discs (DVD) or other optical disc storage, magnetic cassettes, magnetic tape, magnetic disc storage or other magnetic storage devices, or any other medium which can be used to store the desired information and which can be accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 330 includes computer storage media in the form of volatile and/or nonvolatile memory such as ROM 331 and RAM 332. A basic input/output system (BIOS) 333, containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 7 illustrates operating system 334, application programs 335, other program modules 336, and program data 337.

The computer 310 may also include other removable/non-removable, volatile/nonvolatile computer storage media. By way of example only, FIG. 7 illustrates a hard disc drive 341 that reads from or writes to a non-removable, nonvolatile magnetic media and a magnetic disc drive 351 that reads from or writes to a removable, nonvolatile magnetic disc 352. Computer 310 may further include an optical media reading device 355 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 341 is typically connected to the system bus 321 through a non-removable memory interface such as interface 340; magnetic disc drive 351 and optical media reading device 355 are typically connected to the system bus 321 by a removable memory interface, such as interface 350.

The drives and their associated computer storage media discussed above and illustrated in FIG. 7 provide storage of computer readable instructions, data structures, program modules and other data for the computer 310, including for example the software application program implementing the present system. In FIG. 7, for example, hard disc drive 341 is illustrated as storing operating system 344, application programs 345, other program modules 346, and program data 347. These components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and a pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 7. The logical connections depicted in FIG. 7 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 7 illustrates remote application programs 385 as residing on memory device 381. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

I claim:

1. A computer implemented method of modeling a business, comprising the steps of:
(a) modeling a business;
(b) receiving a plurality of regulatory practices representing regulatory practices applicable to the business;
(c) receiving one or more defined properties for each regulatory practice of the plurality of regulatory practices, the properties representing properties of the regulatory practices;
(d) linking one or more of the plurality of regulatory practices to an information technology service of the business so that the one or more regulatory practices are performed automatically by the information technology service of the business.

2. A computer implemented method as recited in claim 1, further comprising a step (e) of exchanging data between the information technology service and at least one of the regulatory practices and the business model.

3. A computer implemented method as recited in claim 1, wherein steps (b) and (c) are performed after said step (a) is completed.

4. A computer implemented method as recited in claim 1, wherein steps (c) and (d) are performed while steps (a) and (b) are performed.

5. A computer implemented method as recited in claim 1, wherein the one or more regulatory practices performed automatically by the information technology service of the business include at least one of monitoring, managing, keeping track of, reporting on and implementing a regulatory practice, and/or an aspect of the business model impacted by a regulatory practice.

6. A computer implemented method as recited in claim 1, said step (b) of receiving a plurality of regulatory practices representing regulatory practices applicable to the business comprises the step of receiving rules with which the business must comply by law, and/or by any custom, practice or action formally recognized as binding or enforced by an external agency, controlling authority or within the business.

7. A computer implemented method as recited in claim 6, said step (b) of receiving a plurality of regulatory practices representing regulatory practices applicable to the business comprises the step of receiving rules related to the Sarbanes-Oxley Act.

8. A computer implemented method as recited in claim 6, said step (b) of receiving a plurality of regulatory practices representing regulatory practices applicable to the business comprises the step of receiving internal governance practices imposed by the business for complying with the regulations.

9. A computer implemented method as recited in claim 1, wherein said step (a) comprises at least one of the steps of:
receiving a plurality of defined business capabilities representing capabilities of the business;
receiving one or more defined processes of a business; and
receiving an information technology architecture of the business.

10. A computer implemented method as recited in claim 1, wherein said step (c) of receiving one or more defined properties for each regulatory practice of the plurality of regulatory practices includes at least one of:
(c1) indicating the degree to which a regulatory practice does or does not regularly materially impact the financial performance of the business;
(c2) serving as counters for monthly, quarterly, and annual counts for the time a regulatory practice has impacted performance of the business;
(c3) identifying a person who is responsible for a regulatory practice;
(c4) identifying a person to notify when there is an event requiring notification;
(c5) indicating the geographic location where the regulation is applicable;
(c6) indicating the reporting and/or notification required when an event requires a notice;
(c7) indicating behavior or preventative action to be taken to comply with a regulation;
(c8) indicating the cost of compliance with a regulatory practice;
(c9) indicating the cost of non-compliance with a regulatory practice;
(c10) indicating the business risk of non-compliance with a regulatory practice;
(c11) indicating whether or not a regulatory practice is complied with;
(c12) indicating a notification medium for notifying an individual regarding a regulatory practice;
(c13) indicating the percentage of compliant and/or noncompliant events in a given period of time; and
(c14) indicating an event which triggers that an action needs to be taken in order to comply under a regulatory practice.

11. A computer-readable medium having computer-executable instructions for programming a processor to perform a method of modeling a business, the method comprising the steps of:
(a) receiving a plurality of defined business capabilities representing capabilities of the business;
(b) receiving one or more defined capability attributes for each business capability of the plurality of business capabilities, the capability attributes representing attributes of the business capabilities;
(c) receiving a plurality of regulatory practices representing regulatory practices applicable to the business;
(d) receiving one or more defined properties for each regulatory practice of the plurality of regulatory practices, the properties representing properties of the regulatory practices;
(e) linking one or more of the plurality of regulatory practices to an information technology service of the business so that the one or more regulatory practices are performed automatically by the information technology service of the business.

12. A computer readable medium as recited in claim 11, further comprising a step (f) of exchanging data between the information technology service and at least one of the regulatory practices and the business capabilities.

13. A computer readable medium as recited in claim 11, wherein the one or more regulatory practices performed automatically by the information technology service of the business include at least one of monitoring, managing, keeping track of, reporting on and implementing a regulatory practice, and/or a business capability impacted by a regulatory practice.

14. A computer readable medium as recited in claim 11, further comprising the step (f) of displaying a model of the business over a graphical user interface.

15. A computer implemented method of modeling a business, comprising the steps of:
(a) receiving a plurality of defined business capabilities representing capabilities of the business;
(b) receiving one or more defined capability attributes for each business capability of the plurality of business capabilities, the capability attributes representing attributes of the business capabilities;
(c) receiving a plurality of regulatory practices representing regulatory practices applicable to the business;
(d) receiving one or more defined properties for each regulatory practice of the plurality of regulatory practices, the properties representing properties of the regulatory practices;
(e) formatting the business capabilities, one or more capability attributes, regulatory practices and one or more properties according to a predefined schema;
(f) linking one or more of the plurality of regulatory practices to one or more of the plurality of business attributes;
(g) linking one or more of the plurality of regulatory practices to an information technology service of the business so that the one or more regulatory practices are performed automatically by the information technology service of the business;
(h) exchanging data between the one or more attributes and the one or more properties to model the operation of the business.

16. A computer implemented method as recited in claim 15, wherein said step (e) of formatting the business capabilities, one or more capability attributes, regulatory practices and one or more properties according to a predefined schema comprises the step of formatting the business capabilities, one or more capability attributes, regulatory practices and one or more properties as at least one of logical, binary, octal, decimal, hexadecimal, integer, floating-point, character, character string, and user-defined data types.

17. A computer implemented method as recited in claim 15, wherein the one or more regulatory practices performed automatically by the information technology service of the business include at least one of monitoring, managing, keeping track of, reporting on and implementing a regulatory practice, and/or a business capability impacted by a regulatory practice.

18. A computer implemented method as recited in claim 15, said step (c) of receiving a plurality of regulatory practices representing regulatory practices applicable to the business comprises the step of receiving rules with which the business must comply by law, and/or by any custom, practice or action formally recognized as binding or enforced by an external agency, controlling authority or within the business.

19. A computer implemented method as recited in claim 18, said step (c) of receiving a plurality of regulatory practices representing regulatory practices applicable to the business comprises the step of receiving rules related to the Sarbanes-Oxley Act.

20. A computer implemented method as recited in claim 18, said step (c) of receiving a plurality of regulatory practices representing regulatory practices applicable to the business comprises the step of receiving internal governance practices imposed by the business for complying with the regulations.
